(19) United States
(12) Patent Application Publication
(10) Pub. No.: US 2026/0145406 A1
(43) Pub. Date: May 28, 2026

(54) SEALABLE AND PEELABLE LIDS FOR STAINLESS STEEL CONTAIN-ERS

(71) Applicant: AMCOR FLEXIBLES NORTH AMERICA, INC., Neenah, WI (US)

(72) Inventors: Christoph DIETRICH, Singen (DE); Andreas ZIEGLER, Stetten (CH)

(21) Appl. No.: 19/121,090

(22) PCT Filed: Oct. 28, 2022
(86) PCT No.: PCT/US2022/048245

§ 371 Date: Apr. 14, 2025

(51) Int. Cl. B32B 15/082; B32B 1/00; B32B 7/12; B32B 15/20; B32B 27/30

(52) U.S. Cl. CPC B32B 15/082; B32B 1/00; B32B 7/12; B32B 15/20; B32B 27/308; B32B 2250/03; B32B 2255/06; B32B 2307/31; B32B 2307/748; B32B 2435/02; B32B 2439/02; B32B 2439/66; B32B 2439/70

(57) ABSTRACT

This disclosure relates to multilayer packaging films and methods of producing the same. The multilayer packaging films comprise a sealing layer such as maleic anhydride-grafted ethyl methacrylate (MAH-EMA) and are suitable for peelably adhering to metals such as stainless steel.

### TECHNICAL FIELD

The present disclosure is related to sealable and peelable packaging films for metal containers such as stainless steel.

### BACKGROUND

As food packaging trends to recyclable and/or reusable materials, there is a demand for packaging utilizing metal containers. However, traditional metal containers used for canned food can be difficult and/or dangerous to open. Easy-open ring-pulls offer a more convenient solution compared to cans requiring the use of a can opener but can still be perceived by consumers as difficult and/or unsafe. Flexible peel-off-end-lidding is also available for tinplate metal containers, but typically leaves behind evidence of a seal in the form of a residue on the metal container after the lid is peeled off. Also, tinplate containers are not durable enough for reuse. Accordingly, there is a need for improved metal packaging options for storing food.

### SUMMARY

Embodiments of the disclosure are directed to sealable and peelable packaging films for metal containers. The packaging films described herein can provide hermetic seals to metal containers such as stainless steel cups but can be easily peeled away during opening. In various embodiments, the packaging film leaves little or no residue on the metal container once it has been peeled off. Once the contents of the metal container have been consumed, the metal container can be returned, cleaned, refilled, and resealed, thus allowing for a reusable metal container.

One or more aspects of the present invention relate to a multilayer packaging film comprising a metal foil layer, a sealing layer comprising maleic anhydride-grafted ethyl methacrylate (MAH-EMA) and a tie layer comprising ethylene acrylic acid (EAA) copolymer adhering the metal foil layer to the sealing layer.

In one or more embodiments, the metal foil layer comprises aluminum foil.

In one or more embodiments, the tie layer is in direct contact with the sealing layer and the metal foil layer.

In one or more embodiments, the multilayer packaging film further comprises a lacquer on an outside surface of the metal foil layer.

In one or more embodiments, the sealing layer has a Vicat softening point less than 100° C. according to ASTM D1525, such as a Vicat softening point less than 80° C. according to ASTM D1525. In one or more embodiments, the sealing layer has about 0.1% to about 1% by weight MAH, such as about 0.2% to about 0.5% by weight. In one or more embodiments, the sealing layer has an initial and/or continuous peel strength of about 5 N/15 mm to about 20 N/15 mm when sealed to stainless steel, such as about 8 N/15 mm to about 13 N/15 mm.

In one or more embodiments, the tie layer and sealing layer are coextruded.

Another aspect of the present invention relates to a food or beverage packaging container comprising the multilayer packaging film described herein adhered to a metal container. In one or more embodiments, the multilayer packaging film is provided as a peelable lid for the container. In one or more embodiments, the metal container comprises stainless steel and the sealing layer is directly adhered to the stainless steel.

Another aspect of the present invention relates to a sealed container comprising a peelable lid comprising a sealing layer comprising MAH-EMA and a stainless steel container having one or more edges surrounding an opening, wherein the peelable lid covers the opening and is sealed to the one or more edges.

In one or more embodiments, the sealing layer has a Vicat softening point less than 100° C. according to ASTM D1525, such as a Vicat softening point less than 80° C. according to ASTM D1525. In one or more embodiments, the sealing layer has about 0.1% to about 1% by weight MAH, such as about 0.2% to about 0.5% by weight. In one or more embodiments, the sealing layer has an initial and/or continuous peel strength of about 5 N/15 mm to about 20 N/15 mm when sealed to stainless steel, such as about 8 N/15 mm to about 13 N/15 mm.

In one or more embodiments, the sealed container is suitable for storing a food or beverage. In one or more embodiments, the sealed container further comprises a food or beverage stored within the container.

In one or more embodiments, the peelable lid further comprises a metal foil layer and a tie layer comprising EAA copolymer adhering the metal foil layer to the sealing layer.

In one or more embodiments, the metal foil layer comprises aluminum foil.

In one or more embodiments, the sealed container further comprises a lacquer on an outside surface of the metal foil layer.

In one or more embodiments, the tie layer and sealing layer are coextruded.

Another aspect of the present invention relates to a sealed container comprising a peelable lid comprising a sealing layer, and a stainless steel container having one or more edges surrounding an opening, wherein the peelable lid covers the opening and is sealed to the one or more edges, and wherein the seal provided by the peelable lid, and the one or more edges has an initial and/or continuous peel force of about 5 N to about 20 N.

In one or more embodiments, the sealing layer has a Vicat softening point less than 100° C. according to ASTM D1525, such as a Vicat softening point less than 80° C. according to ASTM D1525.

In one or more embodiments, the sealed container is suitable for storing a food or beverage. In one or more embodiments, the sealed container further comprises a food or beverage stored within the container.

### BRIEF DESCRIPTION OF THE DRAWINGS

The disclosure may be more completely understood in consideration of the following detailed description of various embodiments of the disclosure in connection with the accompanying Figures, in which:

FIG. 1 illustrates a schematic cross-sectional view of an embodiment of a multilayer packaging film as described herein;

FIGS. 2 and 3 illustrate schematic cross-sectional views of different embodiments of multilayer packaging films as described herein sealed to a metal surface;

FIG. 4 illustrates a perspective view of an embodiment of a sealed container having a multilayer packaging film as a peelable lid; and

FIG. 5 illustrates a perspective view of an embodiment of a partially opened container having a multilayer packaging film as a peelable lid.

The Figures show some, but not all embodiments. The elements depicted in the Figures are illustrative and not necessarily to scale, and the same (or similar) reference numbers denote the same (or similar) features throughout the Figures.

### DETAILED DESCRIPTION

Provided herein are multilayer packaging films that can provide hermetic seals on metal surfaces (e.g., stainless steel). It has surprisingly been found that materials such as maleic anhydride-grafted ethyl methacrylate (MAH-EMA) show sealability with stainless steel yet can be easily peeled away leaving little or no residue behind. It has also been found that seals between the multilayer film and stainless steel, produced and tested according to this disclosure, having a peel strength of about 5 N/15 mm to about 20 N/15 mm, particularly about 8 N/15 mm to about 13 N/15 mm, provide this desired peelable seal. Moreover, when combined with a tie layer such as ethylene acrylic acid (EAA) copolymer, the multilayer packaging films can retain their structure when peeled off, rather than delaminating at one or more layer interfaces or within one or more layers.

The multilayer packaging films described herein comprise a combination of two or more layers. The term “layer” as used herein, refers to a building block of films. A layer is a structure of a single material type or a homogeneous blend of materials. A layer may be a single polymer, a blend of materials within a single polymer type or a blend of various polymers. A layer may contain metallic materials and may have additives. Layers may be continuous with the film or may be discontinuous or patterned. Both layers and films have a relatively insignificant thickness (z-direction) as compared to their respective length and width (x-y direction).

All layers and films described herein have two major surfaces, opposite each other, defined by the x-y plane. The term “outer layer” as used herein refers to one or more layers of the packaging film that are on either major surface of the film, i.e., the layers that are not between two other layers of that film. As described herein, the packaging film has an exterior surface that becomes the exterior of a package in which the film is used. When formed into a package, the exterior surface of the film is exposed to the environment. In one or more embodiments, a metal foil layer defines the exterior surface of the film, is facing away from the packaged product, and is exposed to the environment. In one or more embodiments, a printing layer defines the exterior surface of the film, is facing away from the packaged product, and is exposed to the environment. As described herein, the packaging film has an interior surface that becomes the interior of a package in which the film is used, e.g., the lid of the package. When formed into a package, the interior surface is exposed to the packaged product. In one or more embodiments, the sealing layer defines the interior surface of the film and is exposed to the packaged product.

The packaging films as described herein comprise a sealing layer. In one or more embodiments, the sealing layer may comprise MAH-EMA. In one or more embodiments, the sealing layer has about 0.1% to about 1% by weight MAH, such as about 0.2% to about 0.5% by weight MAH. An exemplary sealing layer material is BYNEL™ 21E4817 available from The Dow Chemical Company. In one or more embodiments, the sealing layer has a Vicat softening point less than 100° C. according to ASTM D1525, such as a Vicat softening point less than 80° C. according to ASTM D1525.

The packaging films as described herein may further comprise a metal foil layer. Exemplary metal foils include, but are not limited to, aluminum metal foils.

The packaging films as described herein may further comprise a tie layer adhering the sealing layer to the metal foil layer. Exemplary tie layers include, but are not limited to, EAA copolymers and ethylene methyl acrylate (EMA) copolymers. In one or more embodiments, the EAA copolymer comprises about 2% to about 10% by weight acrylic acid, such as about 6% acrylic acid. An exemplary tie layer material is PRIMACOR™ 3003 Copolymer available from SK Chemicals.

In one or more embodiments, the metal foil layer and the tie layer are coextensive. In one or more embodiments, the sealing layer and the tie layer are coextensive. In one or more embodiments, the metal foil layer, tie layer, and sealing layer are coextensive.

As used herein, the term “adjacent” means that the items, such as layers of a film, are near each other, with or without intervening material, such as an adhesive layer. As used herein, the term “directly adjacent,” “directly connected” or “in direct contact with” means that the items are in contact with each other, without intervening material.

One or more of the layers or films of the packaging films may be coextensive with one another. As described herein, “coextensive” means that one or more layers may occupy the same area. In one or more embodiments, the metal foil layer and the tie layer are directly adjacent. In one or more embodiments, the sealing layer and the tie layer are directly adjacent.

The packaging films as described herein may further include additional layers and/or coatings. In one or more embodiments, the packaging film further comprises a lacquer applied to the metal foil layer (e.g., aluminum).

As used herein, the term “lacquer” refers to a layer or series of sub-layers that have been printed onto a film. The layer or sub-layers may include pigment containing materials (i.e., colored ink), protective layers (i.e., over-lacquer) and ink receptive primers. Each of the lacquer sub-layer(s) may be independently continuous with the other layers of the film or independently discontinuous (i.e., patterned). Printing of the lacquer layer may be done by any known printing method including, but not limited to, flexographic gravure printing, rotogravure printing, gravure coating, and digital printing methods. Sub-layers within the lacquer layer may be applied by the same process or using different types of processes. In one or more embodiments, the lacquer is free or substantially free of pigment material. The protective layer is intended for protecting the colored ink against aggressions from the environment. The lacquer may also be used to provide a glossy or matte aspect to the external surface.

In various embodiments, the sealing layer as described herein is sealed to a metal surface, such as a surface of a metal container. In such a configuration, the sealing layer is in direct contact with the metal surface. Portions of the sealing layer may be exposed to contents (e.g., food or beverages) stored within the metal container.

Examples of metal containers include, but are not limited to, stainless steel containers. In one or more embodiments, the metal container is a stainless steel cup. As used herein, “stainless steel” refers to an alloy of iron and chromium that has enhanced resistance to rusting and corrosion compared to iron and/or iron alloys without chromium. In one or more embodiments, the stainless steel comprises at least 10% chromium, such as 10% to 30% to chromium. In one or more embodiments, the stainless steel includes additional components such as nickel and/or carbon. In one or more embodiments, the stainless steel has good durability and resistance to corrosion, and thus it is a good candidate for a reusable metal container compared to other metal container options (e.g., tinplate). The stainless steel may have a surface that is mechanically treated such as a brushed or polished surface.

Advantageously, the lidding described herein can be applied to a stainless steel container that has been recovered, washed, recycled and/or reused. The sealing performance is not hindered by these processes. The sealing performance of the multilayer film described herein has the same superior sealing characteristics, including peel strength and no residue peel, on a first used stainless steel container and on a stainless steel container that has been recovered and washed.

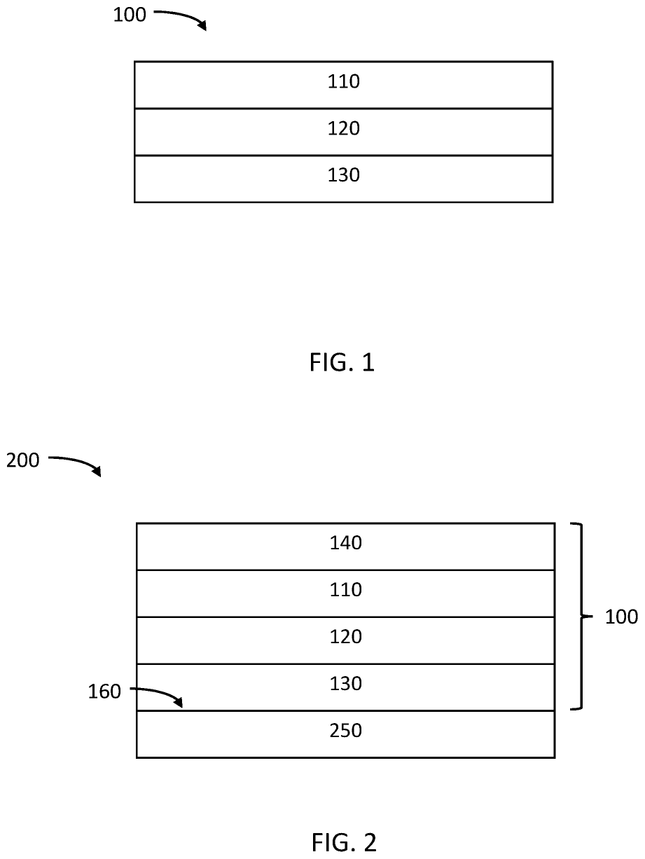

FIG. 1 is a schematic cross-sectional view of an embodiment of a multilayer packaging film 100. FIG. 1 illustrates a multilayer packaging film 100 having a metal foil layer 110, a sealing layer 130, and a tie layer 120 attaching the metal foil layer 110 to the sealing layer 130. As shown in FIG. 1, the tie layer 120 can be in direct contact with the sealing layer 130 and the metal foil layer 110. Alternatively, one or more layers can be in between the tie layer 120 and the sealing layer 130 and/or in between the tie layer 120 and the metal foil layer 110.

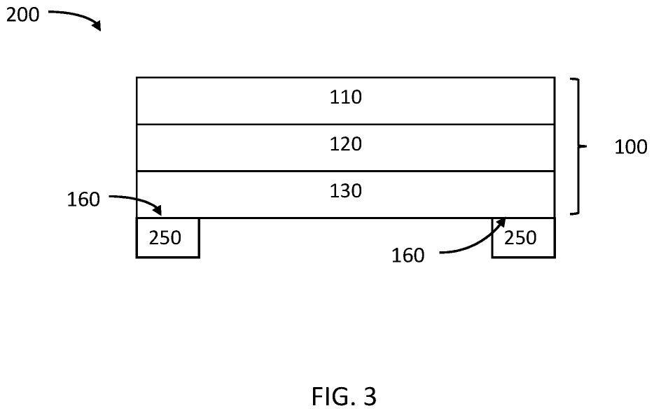

FIG. 2 is a schematic cross-sectional view of an embodiment of a seal portion of a sealed container 200 comprising multilayer packaging film 100 and a metal surface 250. As with FIG. 1, FIG. 2 illustrates a multilayer packaging film 100 having a metal foil layer 110, a sealing layer 130, and a tie layer 120 attaching the metal foil layer 110 to the sealing layer 130. FIG. 2 also shows an optional protective lacquer 140 applied to the metal foil layer 110. FIG. 2 also shows the seal 160 formed at the interface of the sealing layer 130 and the metal surface 250. The metal surface can be a portion of a metal container, such as the edge of a metal cup (e.g., stainless steel cup).

FIG. 3 is a schematic cross-sectional view of an embodiment of a sealed container 200 comprising multilayer packaging film 100 and one or more metal surfaces 250. As with FIG. 2, FIG. 3 illustrates a multilayer packaging film 100 having a metal foil layer 110, a sealing layer 130, and a tie layer 120 attaching the metal foil layer 110 to the sealing layer 130. FIG. 3 also shows the seal 160 formed at the interface of the sealing layer 130 and each metal surface 250, as well as portions of sealing layer 130 that are not in contact with a metal surface 250. Thus, as can be seen from FIG. 3, that portions of the sealing layer 130 may exposed to the contents within a container comprising the metal surfaces 250. The metal surfaces may be a portion of a metal container, such as the edge of a metal cup (e.g., stainless steel cup).

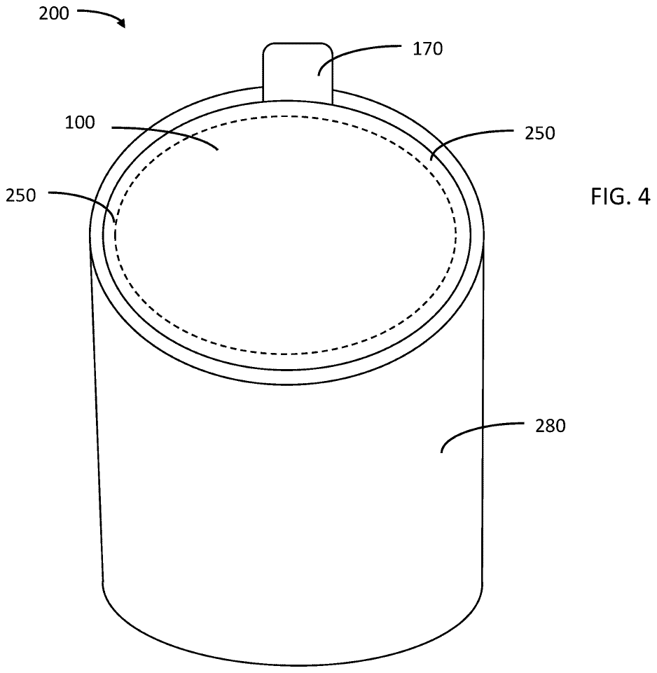

FIG. 4 is a perspective view of an embodiment of a sealed container 200 having a multilayer packaging film 100 as a peelable lid. The metal surface 250 is sealed to the lid at the sealing layer (not shown). The metal surface 250 is covered by the lid in this view, and the inside perimeter of the covered metal surface 250 is indicated by the dashed line. In the embodiment shown in FIG. 4, the metal surface 250 is a portion of a metal container 280. The lid further comprises a tab 170 for the user to grab when peeling open the lid. The embodiment shown in FIG. 4 also illustrates an uncovered portion of the container 280 that optionally extends past the lid comprising the multilayer packaging film 100. The sealed container 200 is filled with contents (not shown) in the cavity defined between the lid and the walls of the metal container 280.

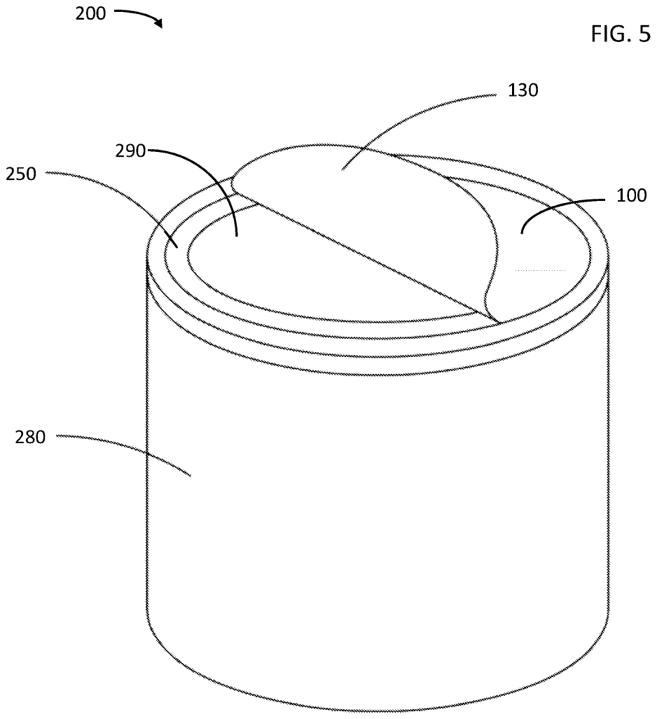

FIG. 5 is a perspective view of an embodiment of a partially opened container 200 having a multilayer packaging film 100 as a peelable lid. The lid has been partially removed to expose a portion of the metal surface 250 and a portion of the sealing layer 130. Another portion of metal surface 250 is still sealed to a portion of the lid at the sealing layer 130, and this portion of the metal surface 250 is covered by the lid in this view. In the embodiment shown in FIG. 5, the metal surface 250 is a portion of a metal container 280. The partially opened container 200 is filled with contents (not shown) in the cavity 290 defined between the lid and the walls of the metal container 280.

Any of the metal surface/sealing layer seals described herein (e.g., at the interface of the metal surface of a metal container and a lid comprising a multilayer packaging film with a sealing layer) can be peelably removed. For example, in an exemplary method of opening a sealed container having such a lid, the user grabs a portion of the lid (e.g., a tab) and pulls the lid to peel it away from the metal surface. The initial resistance to peeling is the initial peel strength, and the resistance to continued peeling of the lid from the metal surface is the continuous peel strength. Typically, the initial peel strength is higher than the continuous peel strength. In various embodiments, the peeling of the lid from the metal surface leaves little or no residue on the metal surface, thus demonstrating adhesive separation of the sealing layer from the metal surface rather than cohesive failure of the sealing layer or other layer(s) of the lid.

### Examples

In the following experimental examples, Example films 1-5 and 7-8 are comparative while Example film 6 is according to this disclosure. The various multilayer packaging films were sealed to 10 mm wide stainless steel bars at a sealing temperature of 220° C., at a sealing pressure of 467 N/cm² for a duration of 1 second. The seal between the multilayer packaging films and the stainless steel bars, having a width of 10 mm, were tested for peel strength according to the protocol below, and the results are provided in Table 1. The initial peel strength is the force measure to initiate the peel and the continuous peel strength is the average force measured along the remainder of the seal.

The following protocol was used to determine the peel strength, which generally follows ASTM F88 except as noted:

### a) Test Devices/Parameters/Settings

| Device | Parameter | Setting | |
|---|---|---|---|
| Lab Heat Sealer | sealing jaw width | 10 | mm |
| | sealing pressure | 467 N/cm² ± | |
| | | 3.33 N/cm² | |
| | top bar sealing | 220° C. ± | |
| | temperature | 5° C. | |
| | bottom bar sealing | 220° C. ± | |
| | temperature | 5° C. | |
| | sealing time | 1 | second |
| Tensile Testing Unit | pre-travel | 2 | mm |
| | measuring path | 10 | mm |
| | overtravel | 2 | mm |
| | test speed | 100 | mm/min. |

| | |
|---|---|
| pull angle | 180° |

Cut a strip of the multilayer film in the running direction approximately 150 mm long.
Place the film strip with the sealing layer side against the bare strip of stainless steel and into the lab heat sealer to seal.
Care must be taken to ensure complete sealing across the width of the stainless steel strip (10 mm width).
The stainless steel strips must be thoroughly clean, since finger sweat/grease etc. will have a negative effect on them effect seal seam adhesion.
After the sample has cooled to room temperature, clamp the sample in the tensile testing unit for standard 180° peel testing.
The adhesive strength is assessed in N/15 mm (e.g., 20.0N/15 mm).

TABLE 1
Overview of Peel Strength

| | | | | Initial | Continuous |
|---|---|---|---|---|---|
| | Metal Foil | Tie | Sealing | Peel Strength | Peel Strength |
| Example | Layer | Layer | Layer | (N/15 mm) | (N/15 mm) |
| 1 | Aluminum | Nucrel ™ | PE Peel/ | 14.3 | 13.3 |
| | (90 μm) | 30707 | Surlyn ™ 1705 | | |
| 2 | Aluminum | Nucrel ™ | Surlyn ™ 1662 | 3.0 | 2.6 |
| | (60 μm) | 3990 | | | |
| 3 | Aluminum | Nucrel ™ | PE Peel/ | 15.8 | 13.9 |
| | (60 μm) | 30707 | Nucrel ™ 30707 | | |
| 4 | Aluminum | Nucrel ™ | PE Peel/ | 13.5 | 12.4 |
| | (90 μm) | 30707 | Nucrel ™ 3990 | | |
| 5 | Aluminum | Nucrel ™ | PE Peel/ | 0.0 | 0.0 |
| | (90 μm) | 30707 | Yparex9207 | | |
| 6 | Aluminum | Primacor ™ | Bynel ™ | 12.3 | 9.1 |
| | (60 μm) | 3003 | 21E4817 | | |
| 7 | Aluminum | Nucrel ™ | PE Peel/ | 9.1 | 3.7 |
| | (90 μm) | 30707 | Tymax ® 7501 | | |
| 8 | Aluminum | Nucrel ™ | PE Peel/ | 3.1 | 1.1 |
| | (90 μm) | 30707 | EMAC ® Plus | | |
| | | | SP1307 | | |

Nucrel ™ polymers and Surlyn ™ polymers are available from Dow Chemical
EMAC ® Plus polymers and Tymax ® polymers are available from Westlake Chemical

As previously discussed with reference to peeling the multilayer films from containers, when peeling the multilayer films from the stainless steel strips in the 180° peel testing, there is an initial peel strength which may be higher and a continuous peel strength along the remaining path of the seal. As shown in Table 1, these are reported separately. The continuous peel strength does not include the initial peel strength “peak”.

When testing the peel strength of the multilayer films disclosed herein to stainless steel, using the test method described herein, the initial peel strength is between 5 N/15 mm and 20 N/15 mm, or between 15 N/15 mm and 20 N/15 mm.

When testing the peel strength of the multilayer films disclosed herein to stainless steel, using the test method described herein, the continuous peel strength is between 5 N/15 mm and 20 N/15 mm, or between 8 N/15 mm and 13 N/15 mm, or between 5 N/15 mm and 12 N/15 mm.

Upon visual inspection, Examples 1, 3 and 4 left residue on the stainless steel bars after peeling. It appeared that the multilayer films underwent at least partial delamination (i.e., interlayer or intralayer (cohesive) failure) for these Examples.

Examples 2, 5, 7 and 8 did not leave residue, but had poor adhesions that were less than 5 N/15 mm after the initial peeling had begun. Such low continuous peels strength can appear to a user to be insufficiently sealed.

Example 6 (MAH-EMA sealing layer with EAA copolymer tie layer) had beneficially high peel strength of >5 N/15 mm yet did not leave visible residue once peeled.

Although the disclosure herein has been described with reference to particular embodiments and Inventive Examples, it is to be understood that these embodiments and Inventive Examples are merely illustrative of the principles and applications of the present disclosure.

1. A multilayer packaging film comprising:
a metal foil layer;
a sealing layer comprising maleic anhydride-grafted ethyl methacrylate (MAH-EMA); and
a tie layer comprising ethylene acrylic acid (EAA) copolymer adhering the metal foil layer to the sealing layer.

2. The multilayer packaging film of claim 1, wherein the metal foil layer comprises aluminum foil.

3. The multilayer packaging film of claim 1, wherein the tie layer is in direct contact with the sealing layer and the metal foil layer.

4. The multilayer packaging film of claim 1, further comprising a lacquer on a surface of the metal foil layer opposite the tie layer.

5. The multilayer packaging film of claim 1, wherein the sealing layer has a Vicat softening point less than 100° C. according to ASTM D1525.

6. The multilayer packaging film of claim 1, wherein the sealing layer has about 0.1% to about 1% by weight MAH.

7. The multilayer packaging film of claim 1, wherein the sealing layer has a continuous peel strength of about 5 N/15 mm to about 20 N/15 mm when sealed to stainless steel and tested according to the method provided in this disclosure.

8. The multilayer packaging film of claim 1, wherein the tie layer and sealing layer are coextruded.

9. A food or beverage packaging container comprising a peelable lid comprising the multilayer packaging film of claim 1 adhered to a metal container.

10. The food or beverage packaging container of claim 9, wherein the metal container comprises stainless steel and the sealing layer is directly adhered to the stainless steel.

11. A sealed container comprising:
a peelable lid comprising a sealing layer comprising maleic anhydride-grafted ethyl methacrylate (MAH-EMA); and
a stainless steel container having one or more edges surrounding an opening, wherein the peelable lid covers the opening and is sealed to the one or more edges.

12. The sealed container of claim 11, wherein the sealing layer has a Vicat softening point less than 100° C. according to ASTM D1525.

13. The sealed container of claim 11, wherein the sealing layer has about 0.1% to about 1% by weight MAH.

14. The sealed container of claim 11, wherein the sealed container is suitable for storing a food or beverage.

15. The sealed container of claim 11, further comprising a food or beverage stored within the container.

16. The sealed container of claim 11, wherein the peelable lid further comprises a metal foil layer and a tie layer comprising ethylene acrylic acid (EAA) copolymer adhering the metal foil layer to the sealing layer.

17. The sealed container of claim 16, wherein the metal foil layer comprises aluminum foil.

18. The multilayer packaging film of claim 16, further comprising a lacquer on an outside surface of the metal foil layer.

19. The multilayer packaging film of claim 16, wherein the tie layer and sealing layer are coextruded.

20. A sealed container comprising:
a peelable lid comprising a sealing layer; and
a stainless steel container having one or more edges surrounding an opening, wherein the peelable lid covers the opening and is sealed to the one or more edges.

21. The sealed container of claim 20, wherein the sealing layer has a Vicat softening point less than 100° C. according to ASTM D1525.

22. The sealed container of claim 20 or 21, wherein the sealed container is suitable for storing a food or beverage.

23. The sealed container of claim 20, further comprising a food or beverage stored within the container.
